(19) United States
(12) Patent Application Publication
(10) Pub. No.: US 2021/0256431 A1
(43) Pub. Date: Aug. 19, 2021

(54) METHODS FOR UNLOCKING SHARED BIKES

(71) Applicant: Shanghai Zhangmen Science and Technology Co., LTD., Shanghai (CN)

(72) Inventors: Xiaolei CHEN, Shanghai (CN); Xiaoshu WANG, Shanghai (CN)

(21) Appl. No.: 17/170,888

(22) Filed: Feb. 9, 2021

Related U.S. Application Data
(63) Continuation of application No. PCT/CN2019/099895, filed on Aug. 9, 2019.

(30) Foreign Application Priority Data
Aug. 10, 2018 (CN) 201810928969.3

(51) Int. Cl. G06Q 10/02; G06Q 50/30; G07C 9/00; G07C 9/38; H04W 4/02; H04W 4/12

(52) U.S. Cl. CPC G06Q 10/02; G06Q 50/30; H04W 4/12; G07C 9/38; H04W 4/025; G07C 9/00571

(57) ABSTRACT

Embodiments of the present application disclose methods for unlocking shared bikes. A specific embodiment of the method comprises: receiving a bike-use request transmitted by a terminal, and the bike-use request is generated by the terminal upon detecting a user's selection operation of identifiers of shared bikes located near a target location and displayed on a map; transmitting a bike-use instruction to a target shared bike, so that the target shared bike sends out prompt information, and the target shared bike comprises the shared bike requested by the bike-use request; generating feedback information for the bike-use request, and transmitting the feedback information to the terminal; and receiving confirmation information on the feedback information transmitted by the terminal, and transmitting an unlocking instruction to the target shared bike.

### CROSS REFERENCE TO THE RELATED APPLICATION

This application is the continuation application of International Application No. PCT/CN2019/099895, filed on Aug. 9, 2019, which is based upon and claims priority to Chinese Patent Application No. 201810928969.3, filed on Aug. 10, 2018, the entire contents of which are incorporated herein by reference.

### FIELD

Embodiments of the present application relate to computer technology, and specifically relate to methods for unlocking shared bikes.

### BACKGROUND

With the development of science and technology, shared bikes have gradually become one of commonly used transportation for people. Currently, existing shared bikes are generally unlocked by people via scanning QR codes on bike bodies or entering bike numbers. However, if both QR codes on bike bodies and bike numbers are damaged, bikes generally cannot be unlocked by such unlocking methods. This would cause bikes to be unusable, affecting utilization rate of bikes.

### SUMMARY

Embodiments of the present application propose methods for unlocking shared bikes.

In a first aspect, embodiments of the present application propose a method, implemented at a server, for unlocking a shared bike. The method comprises: receiving a bike-use request transmitted by a terminal, and the bike-use request is generated by the terminal upon detecting a user's selection operation of identifiers of shared bikes located near a target location and displayed on a map; transmitting a bike-use instruction to a target shared bike so that the target shared bike sends out prompt information, and the target shared bike comprises the shared bike requested by the bike-use request; generating feedback information for the bike-use request, and transmitting the feedback information to the terminal; and receiving confirmation information on the feedback information transmitted by the terminal, and transmitting an unlocking instruction to the target shared bike.

In some embodiments, the shared bikes displayed on the map comprise bikes that cannot be unlocked normally.

In some embodiments, transmitting the bike-use instruction to the target shared bike comprises: determining whether the target shared bike is an available bike that cannot be unlocked normally; and transmitting the bike-use instruction to the target shared bike if it is determined that the target shared bike is an available bike that cannot be unlocked normally.

In some embodiments, the prompt information comprises at least one of a sound prompt, a vibration prompt or a light prompt; and prompt information sent out by shared bikes of different production batches are different; or transmitting the bike-use instruction to the target shared bike comprises: acquiring current location information of the target shared bike, allocating prompt information to the target shared bike; generating a bike-use instruction comprising the allocated prompt information, and transmitting the bike-use instruction to the target shared bike; and prompt information sent out by shared bikes located in a same area are different, or prompt information sent out by shared bikes located in a same area within a same time period are different.

In some embodiments, generating the feedback information for the bike-use request comprises: acquiring the prompt information of the target shared bike, and generating feedback information comprising the prompt information of the target shared bike.

In some embodiments, the method further comprises: receiving first feedback information transmitted by the target shared bike which is used to characterize that the bike is currently in an unlocked state, starting charging, and removing an identifier of the target shared bike from the map; and receiving second feedback information transmitted by the target shared bike which is used to characterize that the bike is currently in a locked state, stopping charging, and redisplaying the identifier of the target shared bike on the map; and transmitting charging information to the terminal.

In some embodiments, before transmitting the bike-use instruction to the target shared bike, the method further comprises: determining whether a number of shared bikes requested by the bike-use request is one; and in response to determining that the number of shared bikes requested by the bike-use request is not one, selecting at least one shared bikes near the target location as target shared bike(s).

In some embodiments, if at least two shared bikes near the target location are selected as target shared bikes, transmitting the unlocking instruction to the target shared bike comprises: acquiring current location information of the user and the target shared bikes; selecting a target shared bike from the target shared bikes according to the acquired current location information; and transmitting the unlocking instruction to the selected target shared bike.

In some embodiments, if at least two shared bikes near the target location are selected as target shared bikes and prompt information sent out by the target shared bikes are different, generating the feedback information for the bike-use request comprises: acquiring prompt information and/or bike numbers of the target shared bikes, and generating feedback information comprising the prompt information and/or the bike numbers of the target shared bikes; and receiving confirmation information on the feedback information transmitted by the terminal, and transmitting the unlocking instruction to the target shared bike comprises: receiving the confirmation information transmitted by the terminal, and transmitting the unlocking instruction to the target shared bike indicated by the confirmation information, and the confirmation information is used to characterize the target shared bike selected by the user.

In a second aspect, embodiments of the present application propose an apparatus, arranged at a server, for unlocking a shared bike. The apparatus comprises: a bike-use request receiving device configured to receive a bike-use request transmitted by a terminal, and the bike-use request is generated by the terminal upon detecting a user's selection operation of identifiers of shared bikes located near a target location and displayed on a map; a bike-use instruction transmitting device configured to transmit a bike-use instruction to a target shared bike so that the target shared bike sends out prompt information, and the target shared bike comprises the shared bike requested by the bike-use request; a feedback information transmitting device configured to generate feedback information for the bike-use request, and transmit the feedback information to the terminal; an unlocking instruction transmitting device configured to receive confirmation information on the feedback information transmitted by the terminal, and transmit an unlocking instruction to the target shared bike.

In a third aspect, embodiments of the present application propose a method, implemented at a terminal, for unlocking a shared bike. The method comprises: transmitting a bike-use request to a server upon detecting a user's selection operation of identifiers of shared bikes located near a target location and displayed on a map is detected, so that the server transmits a bike-use instruction to a target shared bike so that the target shared bike sends out prompt information, and generates feedback information for the bike-use request, and the target shared bike comprises the shared bike requested by the bike-use request; receiving and presenting the feedback information transmitted by the server; and transmitting confirmation information on the feedback information to the server when the user arrives where the target shared bike is currently located, so that the server transmits an unlocking instruction to the target shared bike.

In some embodiments, the shared bikes displayed on the map comprise bikes that cannot be unlocked normally.

In some embodiments, the shared bikes displayed on the map further comprise bikes that can be unlocked normally, and identifiers of the bikes that can be unlocked normally are different from identifiers of bikes that cannot be unlocked normally; and transmitting the bike-use request to the server comprises: determining whether the shared bike selected by the user comprises a bike that cannot be unlocked normally; and transmitting a bike-use request to the server if it is determined that the shared bike selected by the user comprises a bike that cannot be unlocked normally.

In some embodiments, receiving and presenting the feedback information transmitted by the server comprises at least one of: displaying an identifier of the target shared bike on the map, and removing identifiers of other shared bikes; displaying identifiers of shared bikes located near the target location on the map, and an identifier of the target shared bike is different from identifiers of other shared bikes; presenting the prompt information of the target shared bike upon detecting a user's triggering operation of an identifier of the target shared bike displayed on the map, and the feedback information comprises the prompt information of the target shared bike; displaying a bike number of the target shared bike on the map as an identifier, or displaying a bike number of the target shared bike at a location on the map corresponding to the identifier of the target shared bike, and the feedback information comprises the bike number of the target shared bike.

In some embodiments, the method further comprises: receiving and presenting charging information of the target shared bike transmitted by the server.

In a fourth aspect, embodiments of the present application propose an apparatus, arranged at a terminal, for unlocking a shared bike. The apparatus comprises: a bike-use request transmitting device configured to transmit a bike-use request to a server upon detecting a user's selection operation of identifiers of shared bikes located near a target location and displayed on a map, so that the server transmits a bike-use instruction to a target shared bike so that the target shared bike sends out prompt information, and generates feedback information for the bike-use request, and the target shared bike comprises the shared bike requested by the bike-use request; a feedback information receiving device configured to receive and present the feedback information transmitted by the server; a confirmation information transmitting device configured to transmit confirmation information on the feedback information to the server when the user arrives where the target shared bike is currently located, so that the server transmits an unlocking instruction to the target shared bike.

In a fifth aspect, embodiments of the present application propose a method, implemented at a bike, for unlocking a shared bike. The method comprises: receiving a bike-use instruction transmitted by a server, and sending out prompt information, and the bike-use instruction is generated by the server when receiving a bike-use request transmitted by the terminal, and the bike-use request is generated by the terminal upon detecting a user's selection operation of identifiers of shared bikes located near a target location and displayed on a map; receiving an unlocking instruction transmitted by the server, and performing an unlocking operation, and the unlocking instruction is generated by the server when receiving confirmation information on feedback information transmitted by the terminal, and the feedback information is generated and transmitted to the terminal by the server in case of having transmitted the bike-use instruction.

In some embodiments, the bike comprises a bike that cannot be unlocked normally.

In some embodiments, prompt information sent out by shared bikes of different production batches are different; or the bike-use instruction comprises prompt information allocated by the server, and sending out the prompt information comprises: sending out the prompt information indicated by the bike-use instruction.

In some embodiments, the method further comprises: transmitting, to the server, first feedback information which is used to characterize that the bike is currently in an unlocked state, so that the server starts charging and removes an identifier of the target shared bike from the map; and transmitting, to the server, second feedback information which is used to characterize that the bike is currently in a locked state, so that the server stops charging and redisplays the identifier of the target shared bike on the map.

In a sixth aspect, embodiments of the present application propose an apparatus, arranged at a bike, for unlocking a shared bike. The apparatus comprises: a bike-use instruction receiving device configured to receive a bike-use instruction transmitted by a server, and send out prompt information, and the bike-use instruction is generated by the server when receiving a bike-use request transmitted by the terminal, and the bike-use request is generated by the terminal upon detecting a user's selection operation of identifiers of shared bikes located near a target location and displayed on a map; an unlocking device configured to receive an unlocking instruction transmitted by the server, and perform an unlocking operation, and the unlocking instruction is generated by the server when receiving confirmation information on feedback information transmitted by the terminal, and the feedback information is generated and transmitted to the terminal by the server in case of having transmitted the bike-use instruction.

In a seventh aspect, embodiments of the present application propose an electronic device, which comprises: one or more processors; a storage device having one or more programs stored thereon; and the one or more programs, when executed by the one or more processors, cause the one or more processors to implement the method as described in any of the embodiments in the first aspect, the third aspect, or the fifth aspect mentioned above for example.

In an eighth aspect, embodiments of the present application propose a computer-readable medium storing computer programs thereon, and the computer programs, when executed by a processor, implement the method as described in any of the embodiments in the first aspect, the third aspect, or the fifth aspect mentioned above for example.

The method for unlocking a shared bike proposed in the embodiments of the present application comprises: receiving a bike-use request transmitted by a terminal, and transmitting a bike-use instruction to a target shared bike so that the target shared bike sends out prompt information. The bike-use request may be generated by the terminal upon detecting a user's selection operation of identifiers of shared bikes located near a target location and displayed on a map. The target shared bike may comprise the shared bike requested by the bike-use request. Meanwhile, feedback information for the bike-use request may be generated and transmitted to the terminal. In turn, an unlocking instruction may be transmitted to the target shared bike when confirmation information on the feedback information transmitted by the terminal is received. In this way, shared bikes, especially shared bikes without unlocking keys, can be unlocked, which would facilitate the improvement of utilization rate of shared bikes and user experience of shared bikes, and facilitate the improvement of operating incomes of enterprises.

### DESCRIPTIONS OF THE DRAWINGS

Other features, objects, and advantages of the present application will become more apparent by reading the detailed description of non-limiting embodiments with reference to the following drawings:

FIG. 1 is an exemplary system architecture diagram in which one embodiment of the present application can be applied;

FIG. 2 is a flowchart of a first embodiment of a method for unlocking a shared bike according to the present application;

FIG. 3 is a flowchart of a second embodiment of a method for unlocking a shared bike according to the present application;

FIG. 4 is a flowchart of a third embodiment of a method for unlocking a shared bike according to the present application;

FIG. 5 is a flowchart of a fourth embodiment of a method for unlocking a shared bike according to the present application;

FIG. 6 is a schematic diagram of an application scenario of a method for unlocking a shared bike according to the present application; and

FIG. 7 is a schematic structural diagram of a computer system suitable for implementing an electronic device of the embodiments of the present application.

### DETAILED EMBODIMENTS

The following describes the present application in detail with reference to the accompanying drawings and embodiments. It can be understood that the specific embodiments described herein are only used to explain the related disclosure, but not to limit the disclosure. It should also be noted that, for convenience of description, only the parts related to the related disclosure are shown in the drawings.

It should be noted that, in the case of no conflict, the embodiments in the present application and the features in the embodiments can be combined with each other. The application will be described in detail below with reference to the drawings and embodiments.

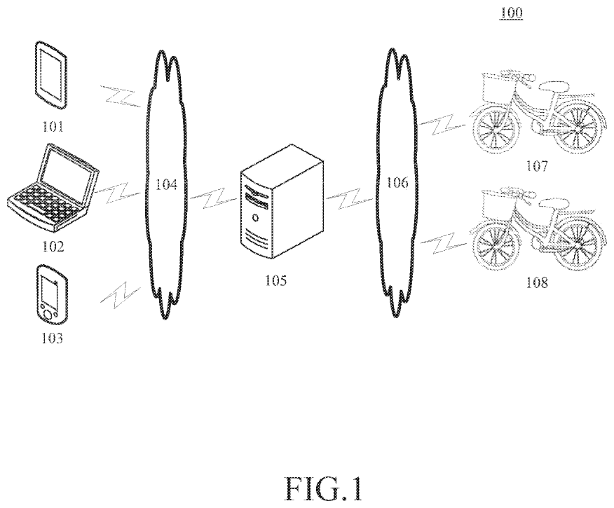

FIG. 1 shows an exemplary system architecture 100 in which the method for unlocking a shared bike according to an embodiment of the present application can be applied.

As shown in FIG. 1, the system architecture 100 may include terminals 101, 102, and 103, networks 104, 106, a server 105, and shared bikes 107, 108. The network 104 may be a medium for providing a communication link between the terminals 101, 102, and 103 and the server 105. The network 106 may be a medium for providing a communication link between the server 105 and the shared bikes 107, 108. The networks 104, 106 may include various connection types of networks, such as wired, wireless communication links, or fiber optic cables, among others.

The user can use the terminals 101, 102, and 103 to interact with the server 105 through the network 104 to receive or send messages and the like. Various client applications can be installed on the terminals 101, 102, and 103, such as shared bike-type applications, map-type applications, payment-type applications, browsers, instant messaging tools, etc.

A user may open the shared bike-type applications installed on the terminals 101, 102, and 103. In this way, the terminals 101, 102, and 103 may transmit a bike-use request to the server 105 upon detecting a user's selection operation of identifiers of shared bikes displayed on a map. The terminals 101, 102, and 103 may receive and present feedback information for the bike-use request transmitted by the server 105. The user may use the terminals 101, 102, and 103 to transmit confirmation information to the server 105 when he/she arrives near the location of the selected shared bike, so that the shared bikes 107, 108 may perform an unlocking operation indicated by the unlocking instruction transmitted by the server 105.

The terminals 101, 102, and 103 herein may be hardware, or may be software. In case of hardware, the terminals 101, 102, and 103 may be various electronic devices that have a display, including but not limited to: smart phones, tablets, wearable devices, e-book readers, MP3 (Moving Picture Experts Group Audio Layer III) players, laptop portable computers and desktop computers, etc. In case of software, terminals 101, 102, and 103 may be installed in the electronic devices listed above. The terminals 101, 102, and 103 may be implemented as multiple software or software modules (e.g., software or software modules for providing distributed services), or as a single software or software module. No specific limitation is made herein.

The server 105 may be a server that provides various services, such as a background server that provides support for various applications installed on the terminals 101, 102, and 103. The background server may analyze the received bike-use request transmitted by the terminals 101, 102, and 103. Thus, the background server may transmit a bike-use instruction to a shared bike requested by the user so that the shared bike sends out prompt information, and the background server may transmit feedback information to the terminals 101, 102, and 103. In addition, the background server may transmit an unlocking instruction to the shared bike requested by the user after receiving the confirmation information transmitted by the terminals 101, 102, and 103, so that the shared bike performs an unlocking operation.

The server 105 herein may also be hardware, or may be software. In case of hardware, the server 105 may be implemented as a distributed server cluster composed of multiple servers, or as a single server. In case of software, the server 105 may be implemented as multiple software or software modules (e.g., software or software modules for providing distributed services), or as a single software or software module. No specific limitation is made herein.

The shared bikes 107, 108 may communicate with the server 105 through the network 106. The shared bikes 107, 108 herein may be various vehicles that can be used with payment, such as existing OFO bikes, BLUEGOGO bikes, and so on. When the shared bikes 107, 108 receive the bike-use instruction transmitted by the server 105, they may send out prompt information so that the user is able to locate them. When the shared bikes 107, 108 receive the unlocking instruction transmitted by the server 105, they may perform an unlocking operation, so that the user can use them.

It should be noted that the method for unlocking a shared bike provided in the embodiments of the present application may generally be performed by the terminals 101, 102, and 103, the server 105 or the shared bikes 107, 108.

It should be understood that the numbers of terminals, networks, servers and shared bikes in FIG. 1 are merely exemplary. Depending on the implementation needs, there may be any number of terminals, networks, servers and shared bikes.

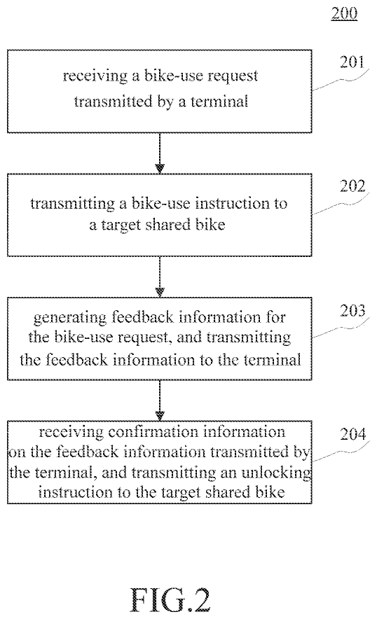

With continued reference to FIG. 2, it shows a flow 200 of a first embodiment of a method for unlocking a shared bike according to the present application. The method for unlocking a shared bike may comprise the following steps.

At step 201, a bike-use request transmitted by a terminal is received.

In this embodiment, an executive entity of the method for unlocking a shared bike (e.g., the server 105 as shown in FIG. 1) may receive a bike-use request transmitted by a terminal (e.g., the terminals 101, 102, and 103 as shown in FIG. 1) by way of a wired connection or a wireless connection. The bike-use request may be used to characterize that the user requested to use a shared bike (e.g., the shared bikes 107, 108 as shown in FIG. 1). As an example, the bike-use request may usually comprise user information and bike information. The user information may comprise for example one or more of a mobile phone number, name, or user ID (identity number), etc. The bike information may comprise, for example, bike number or ID, bike name, etc. As another example, the bike-use request may also comprise location of use information, such as latitude and longitude coordinates, building name, or contact address, etc.

Here, the bike-use request may be generated by the terminal upon detecting a user's selection operation of identifiers of shared bikes located near a target location and displayed on a map. The target location herein may be any location. The user may input the target location in a variety of ways, such as manual input or voice input or selecting on the map as input, etc. A location near a target location generally refers to any location within a preset distance (such as 50 meters or 100 meters, etc.) away from the target location. An identifier of a shared bike may be used to uniquely represent the shared bike on the map. The identifier may include (but is not limited to) at least one of text, sign, image, etc.

It can be understood that a user usually select one shared bike to request for use. That is, the user selects an identifier of a shared bike on the map and then requests for it. That is, a bike-use request usually comprises bike information of the shared bike selected by the user.

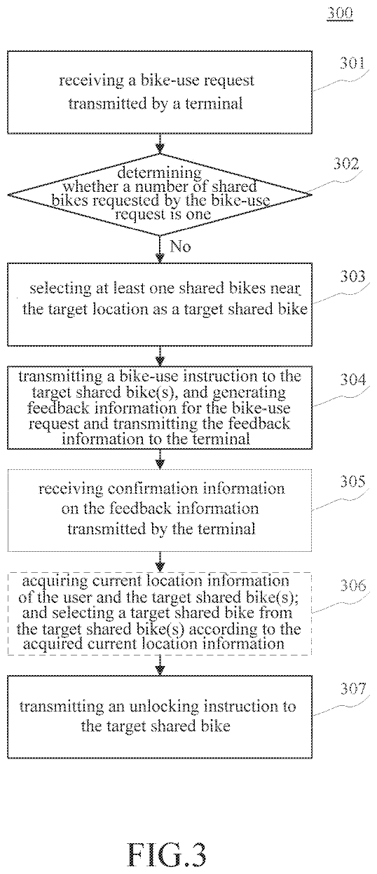

In some implementations of this embodiment, a user may also select none of shared bikes, or select multiple shared bikes. In this case, the method for unlocking a shared bike of the present application is described with reference to the related description of the embodiment in FIG. 3, and details are not described herein again.

In addition, the shared bikes in this embodiment may be bikes that can be unlocked normally or may be bikes that cannot be unlocked normally. Bikes that can be unlocked normally generally refer to shared bikes which can be normally unlocked through a normal unlocking method designed by the factory, such as existing shared bikes that can be unlocked with QR codes or three-dimensional codes. Bikes that cannot be unlocked normally generally refer to shared bikes which cannot be normally unlocked through the normal unlocking method designed by the factory, such as shared bikes whose QR codes or three-dimensional codes, bike numbers, etc. are all damaged. That is, identifiers of bikes that can be unlocked normally and identifiers of bikes that cannot be unlocked normally may be simultaneously displayed on the above-mentioned map. Alternatively, the above-mentioned map may be divided into two types. Identifiers of bikes that can be unlocked normally may be displayed on one type of map, and identifiers of bikes that cannot be unlocked normally may be displayed on the other type of map. At this time, a user who uses the terminal may switch between the maps according to his/her needs.

At step 202, a bike-use instruction is transmitted to a target shared bike.

In this embodiment, if an executive entity receives the bike-use request in step 201, it may transmit a bike-use instruction to a target shared bike by way of a wireless connection so that the target shared bike may send out prompt information. The target shared bike may comprise the shared bike requested by the bike-use request, i.e., the shared bike selected by the user. The prompt information herein may be any information that helps the user to find or locate shared bikes. It may be, for example (but not limited to), a sound prompt (such as ringtones or music, etc.) and/or a light prompt (such as constant lighting or a flashing light). The light may be monochromatic light or colored light generated according to various existing light emitting principles.

As an example, preset prompt information may be stored in a control device of the shared bike. In this way, after the executive entity transmits the bike-use instruction to the target shared bike, the target shared bike may send out the preset prompt information. As another example, after the executive entity receives the bike-use request, it may acquire the pre-stored prompt information, and then generate a bike-use instruction comprising the prompt information. In this way, the target shared bike may send out the prompt information in the bike-use instruction. There is no limitation to the location where the prompt information is stored in the present application. For example, the prompt information may be stored locally at the executive entity or may be stored in the cloud.

In some implementations of this embodiment, if the target shared bike is a bike that cannot be unlocked normally, that is, the user selects an identifier of a bike that cannot be unlocked normally on the map, the executive entity may determine whether the target shared bike is an available bike that cannot be unlocked normally at first before transmitting a bike-use instruction to the target shared bike. “Available” herein mainly refers to that a bike has no fault and is not being requested by other users. When a target shared bike is determined as an available bike that cannot be unlocked normally, a bike-use instruction may be transmitted to the target shared bike. If a target shared bike is not an available bike that cannot be unlocked normally, the executive entity may transmit request failure prompt information to a terminal used by the user to prompt the user to select another bike that cannot be unlocked normally.

It can be understood that, if a target shared bike is a bike that can be unlocked normally, the executive entity may also transmit a bike-use instruction if it is determined that the target shared bike is an available bike.

It should be noted that the prompt information sent out by shared bikes may be the same or different. The prompt information comprises at least one of a sound prompt, a vibration prompt or a light prompt. For example, prompt information sent out by shared bikes of the same production batch may be the same. Prompt information sent out by shared bikes of different production batches may be different. In order to avoid interference caused by prompt information simultaneously sent out by multiple shared bikes near the same location, the executive entity may also allocate different prompt information to the shared bikes located in the same area according to location information of the shared bikes.

In one embodiment, the executive entity may acquire current location information of the target shared bike at first, to allocate prompt information to the target shared bike. As an example, prompt information sent out by shared bikes located in the same area may be different. As another example, prompt information sent out by shared bikes located in the same area within the same time period (such as 15 minutes) may be different. That is, if there are multiple users transmitting bike-use requests for shared bikes near the same target location at the same time or at different time within the same time period, then the executive entity may allocate different prompt information to the shared bikes requested by the multiple users respectively.

After that, the executive entity may generate a bike-use instruction comprising the allocated prompt information, and transmit the bike-use instruction to the corresponding target shared bike. As an example, the executive entity may generate a the bike-use instruction comprising specific content of the prompt information. As another example, both the executive entity and the shared bike store a prompt information list. At this time, the executive entity may generate a bike-use instruction comprising an identifier of the prompt information. The prompt information list may be used to describe the correspondence between the identifier and the prompt information.

At step 203, feedback information for the bike-use request is generated and transmitted to the terminal.

In this embodiment, in case the executive entity has transmitted the bike-use instruction, it may also generate feedback information for the bike-use request received in step 201, and transmit the feedback information to the terminal. The feedback information herein may be information which is used to characterize that the bike-use request is successful. As an example, the feedback information may comprise information such as, “The bike-use instruction has been sent. Please go to the bike.” As another example, the feedback information may comprise a bike number of the target shared bike. In this way, the user may determine whether the shared bike which is currently sending out prompt information is the requested bike according to the bike number.

In some embodiments, if prompt information sent out by shared bikes are different, the executive entity may acquire the prompt information of the target shared bike. As an example, the production batch of the target shared bike may be determined according to the bike number of the target shared bike, and in turn the prompt information may be acquired. As another example, the prompt information which has been allocated to the target shared bike is acquired, and thus feedback information comprising the prompt information of the target shared bike may be generated.

At this time, the terminal may present the feedback information to the user. As an example, the terminal may use a speaker to play a sound prompt. As another example, the terminal may use a flashlight to display a light prompt. As yet another example, the terminal may present a vibration prompt by vibrating itself, and/or display text information on a screen of the terminal. In this way, the user may determine whether the shared bike which is currently sending out the prompt information is the requested bike according to the prompt information presented by the terminal. That is, in absence of a bike number on a body of a bike, the prompt information of the bike may also help to improve convenience for the user to locate the bike.

At step 204, confirmation information on the feedback information transmitted by the terminal is received, and an unlocking instruction is transmitted to the target shared bike.

In this embodiment, if the executive entity receives confirmation information on the feedback information transmitted by the terminal, the executive entity may transmit an unlocking instruction to the target shared bike. The confirmation information herein may be used to characterize that the user confirms to use the shared bike requested by him/her. For example, when the user arrives near a current location of the target shared bike, or has located the target shared bike, he/she may use the terminal to transmit the confirmation information. The confirmation information usually does not comprise an unlocking key of the target shared bike (that is, information required by normal unlocking, such as QR code or three-dimensional code information).

Here, if the target shared bike receives the unlocking instruction, the target shared bike may perform an unlocking operation, and the bike is unlocked. In this way, the user may use the target shared bike.

In one embodiment, after the target shared bike performs the unlocking operation, the executive entity may receive first feedback information transmitted by the target shared bike which is used to characterize that the bike is currently in an unlocked state. At this time, the executive entity may start charging, and an identifier of the target shared bike may be removed from the map. There is no limitation to ways of removing in the present application, such as hiding, deleting. After the user finishes use process and locks the target shared bike, the executive entity may receive second feedback information transmitted by the target shared bike which is used to characterize that the bike is currently in a locked state. At this time, the executive entity may stop charging, and may redisplay the identifier of the target shared bike on the map. Meanwhile, the executive entity may transmit charging information to the terminal. In this way, the user may be aware of the charging information in real time during the use process. The charging information may include but is not limited to at least one of start time of charging, end time of charging, current use duration or current fee, etc.

It can be understood that bikes that cannot be unlocked normally can be unlocked with the unlocking method provided in this embodiment, which can increase utilization rate of bikes that cannot be unlocked normally, and also help to improve user experience and operating incomes of enterprises. Also, a bike-use instruction is transmitted to the target shared bike, which enables the target shared bike to send out prompt information. This can facilitate the location of the bike by the user and would shorten the time that the user takes to locate the bike.

As to bikes which can be unlocked normally, either a conventional unlocking method or the unlocking method provided in this embodiment may be employed. For example, after the user uses the terminal to scan the QR code on a bike body, the bike is always in a being unlocked state or the bike cannot be unlocked for multiple times. In these situations, the unlocking method provided in this embodiment may be employed. That is, the user may use the terminal to interact with the executive entity multiple times to unlock the bike, which not only enriches the methods for unlocking a shared bike, but also helps to shorten unlocking time and reduce the user's waiting time.

The method for unlocking a shared bike provided in this embodiment receives a bike-use request transmitted by a terminal and transmits a bike-use instruction to a target shared bike to enable the target shared bike to send out prompt information. The bike-use request may be generated by the terminal upon detecting a user's selection operation of identifiers of shared bikes located near a target location and displayed on a map. The target shared bike may comprise the shared bike requested by the bike-use request. Meanwhile, feedback information for the bike-use request may be generated and transmitted to the terminal. In turn, an unlocking instruction may be transmitted to the target shared bike when confirmation information on the feedback information transmitted by the terminal is received. In this way, shared bikes, especially shared bikes without unlocking keys, can be unlocked which would help to improve utilization rate of shared bikes and user experience, and also help to improve operating incomes of enterprises.

With further reference to FIG. 3, it shows a flow 300 of a second embodiment of a method for unlocking a shared bike according to the present application. The unlocking method may comprise the following steps.

At step 301, a bike-use request transmitted by a terminal is received.

In this embodiment, an executive entity of the method for unlocking a shared bike (e.g., the server 105 as shown in FIG. 1) may receive a bike-use request transmitted by a terminal (e.g., the terminals 101, 102, and 103 as shown in FIG. 1) by way of a wired connection or a wireless connection. Here, the bike-use request may be generated by the terminal upon detecting a user's selection operation of identifiers of shared bikes located near a target location and displayed on a map. Reference may be made to the related description of step 201 of the embodiment in FIG. 2, and details would not be described herein again. It should be noted that shared bikes displayed on the map in this embodiment mainly refer to bikes that cannot be unlocked normally.

At step 302, it is determined whether a number of shared bikes requested by the bike-use request is one.

In this embodiment, the executive entity may determine whether a number of shared bikes requested by the bike-use request is one. As an example, if there is no bike information in the bike-use request, which indicates that the user does not specify a bike, that is, no bike is selected, the executive entity may determine that the number of shared bikes requested by the bike-use request is not one. As another example, if the bike-use request comprises information of multiple bikes, which indicates that the user selects multiple shared bikes, the executive entity may also determine that the number of shared bikes requested by the bike-use request is not one.

In this embodiment, if the executive entity determines that the number of shared bikes requested by the bike-use request is one, steps 202 to 204 in the embodiment of FIG. 2 may be performed, and details are not described herein again. If the executive entity determines that the number of shared bikes requested by the bike-use request is not one, step 303 may be performed.

At step 303, at least one shared bikes near the target location is selected as target shared bike(s).

In this embodiment, if the executive entity determines that the number of shared bikes requested by the bike-use request is not one, at least one shared bike near the target location may be selected, and the at least one shared bike selected is/are considered as the target shared bike(s). There is no limitation to the way of selecting in the present application, such as selecting randomly or selecting through screening. As an example, a bike whose current location is closer to the target location may be selected. As another example, in order to facilitate the location of the bike by the user, a bike whose current location is located on either side of the road, at an entrance of a store, or near a station (bus station, subway station) may be selected. The selected shared bike is an available bike that cannot be unlocked normally.

In this embodiment, if a shared bike near the target location is selected as the target shared bike, the executive entity may perform steps 202 to 204 with reference to the embodiment of FIG. 2, and details are not described herein again. If at least two shared bikes near the target location are selected as the target shared bikes, the executive entity may continue to perform step 304.

At step 304, bike-use instructions are transmitted to the target shared bikes, and feedback information for the bike-use request is generated and transmitted to the terminal.

In this embodiment, the executive entity may transmit bike-use instructions to the target shared bikes (that is, the at least two shared bikes selected). In this way, the target shared bikes may send out prompt information.

In this embodiment, the executive entity may generate feedback information for the bike-use request at the same time when or after the bike-use instructions are transmitted to the target shared bikes, and transmit the feedback information to the terminal. As an example, the feedback information may comprise information such as “The bike-use instruction has been transmitted to multiple shared bikes.” As another example, the feedback information may comprise bike numbers of the target shared bikes.

As an example, if the prompt information sent out by the target shared bikes are different, the executive entity may acquire the prompt information and/or the bike numbers of the target shared bikes, and generate feedback information comprising the prompt information and/or the bike numbers of the target shared bikes. It should be noted that if the prompt information is voice information comprising a bike number, such as “I am bike A”, at this time, in order to improve efficiency of data processing and transmission, the executive entity may generate feedback information comprising the prompt information or the bike numbers.

At step 305, confirmation information on the feedback information transmitted by the terminal is received.

In this embodiment, the executive entity may receive confirmation information on the feedback information transmitted by the terminal. The confirmation information herein may be used to characterize that the user confirms to use the shared bike. Usually, users will not transmit confirmation information until they arrive near the target location or where the shared bike is located. Therefore, the confirmation information may also be used to characterize that the user has arrived near the target location (or where any of the target shared bikes is located).

In some application scenarios, the confirmation information may also be used to characterize a target shared bike selected by the user. For example, the user may select an identifier from the identifiers of the target shared bikes displayed on the map, or may select one from the target shared bikes according to the prompt information and/or the bike numbers of the target shared bikes in the feedback information. At this time, the terminal may generate confirmation information comprising information related to the target shared bike selected by the user.

Here, if the executive entity determines the target shared bike selected by the user according to the confirmation information, step 307 may be performed. If the user does not select a target shared bike from the target shared bikes, the executive entity may perform step 306.

At step 306, current location information of the user and the target shared bikes are acquired; and a target shared bike is selected from the target shared bikes according to the acquired current location information.

In this embodiment, the executive entity may acquire the current location information of the user by terminal positioning, and may also acquire the current location information of the target shared bikes according to positioning of the target shared bikes. After that, the executive entity may select a target shared bike from the target shared bikes according to the current location information of the user and the current location information of the target shared bikes. As an example, the executive entity may randomly select a target shared bike or select a target shared bike at a preset location (such as a first or second position) from the closest end in the order from the nearest to the farthest in terms of the distance from the current location of the user. As another example, the executive entity may select a target shared bike with a location which can be easily found by the user (such as a location on either side of a road, near a station, etc.) and which is closer to the current location of the user.

At step 307, an unlocking instruction is transmitted to the target shared bike.

In this embodiment, if the confirmation information is used to characterize the target shared bike selected by the user in step 305, the executive entity may transmit an unlocking instruction to a target shared bike indicated by the confirmation information. If the executive entity selects a target shared bike from the target shared bikes in step 306, the executive entity may transmit an unlocking instruction to the selected target shared bike. Reference may be made to related description of step 204 of the embodiment in FIG. 2, and details are not described herein again.

The method for unlocking a shared bike provided in this embodiment describes in detail the process of determining a target shared bike and selecting a target shared bike to transmit the unlocking instruction when the user does not select and specify a shared bike. In this way, the process of the unlocking method is enriched and refined, which helps to expand the scope of application of the method and meet different users' needs.

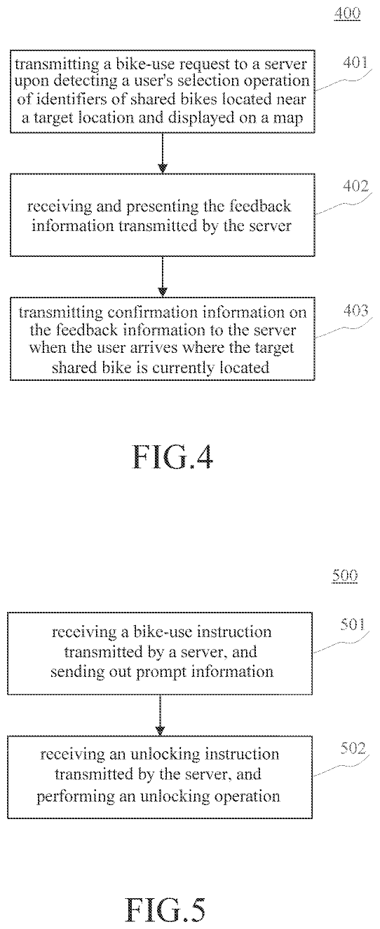

With reference to FIG. 4, it shows a flow 400 of a third embodiment of a method for unlocking a shared bike according to the present application. The unlocking method may comprise the following steps.

At step 401, if a user's selection operation of identifiers of shared bikes located near a target location and displayed on a map is detected, a bike-use request is transmitted to a server.

In this embodiment, if the executive entity of the method for unlocking a shared bike (e.g., the terminals 101, 102, and 103 as shown in FIG. 1) detects a user's selection operation of identifiers of shared bikes located near a target location and displayed on a map, the executive entity may transmit a bike-use request to a server (e.g., the server 105 as shown in FIG. 1). In this way, the server may transmit a bike-use instruction to a target shared bike (e.g., the shared bike 107 or 108 as shown in FIG. 1) to enable the target shared bike to send out prompt information. Meanwhile, the server may generate feedback information for the bike-use request and transmit the feedback information to the terminal. The target shared bike herein may comprise the shared bike requested by the bike-use request. Reference may be made to related description of steps 201 to 203 of the embodiment in FIG. 2, and details are not described herein again.

It can be understood that a user usually select a shared bike to request for use. That is, the user selects an identifier of one shared bike on the map and then transmits a bike-use request through the terminal. In some embodiments, a user may also select none of share bikes, or select multiple shared bikes.

It should be noted that the above shared bikes displayed on the map may comprise bikes that cannot be unlocked normally and/or bikes that can be unlocked normally. In other words, two maps may be used for these two types of bikes separately, or a common map may be used for these two types of bikes. In the situation where a common map is used, in order to facilitate distinguishing between the two types of bikes by the user, identifiers of bikes that cannot be unlocked normally may be different from identifiers of bikes that can be unlocked normally. The “different” mentioned here may refer to that the identifiers themselves are different. For example, the identifier “no” means bikes that cannot be unlocked normally; and the identifier “yes” means bikes that can be unlocked normally. The “different” mentioned here may also refer to that ways of displaying the identifiers are different. For example, the identifiers are displayed in different sizes and/or colors.

In one embodiment, if the unlocking method in this embodiment is only applied to bikes that cannot be unlocked normally, and the shared bikes displayed on the map comprise the above two types of bikes, the executive entity may determine whether the shared bike selected by the user comprises a bike that cannot be unlocked normally before transmitting the bike-use request to the server. If the user selects a shared bike, the executive entity may determine whether the shared bike is a bike that cannot be unlocked normally based on the identifier or bike information. If the shared bike is a bike that cannot be unlocked normally, it may be determined that the shared bike selected by the user comprises a bike that cannot be unlocked normally. If the user selects at least two shared bikes, the executive entity can determine whether there is a bike that cannot be unlocked normally among these shared bikes. If yes, it may be determined that a bike that cannot be unlocked normally is comprised. If it is determined that a bike that cannot be unlocked normally is comprised, the executive entity may transmit a bike-use request to the server. It should be noted that, if the user does not select a shared bike, the executive entity may directly transmit a bike-use request to the server.

At step 402, the feedback information transmitted by the server is received and presented.

In this embodiment, the executive entity may receive feedback information transmitted by the server, and present the feedback information to the user. As an example, feedback information comprising information such as “The bike-use instruction has been transmitted. Please go to the bike.” may be displayed on a screen of the executive entity. As another example, feedback information comprising a bike number of the target shared bike may be displayed on the screen of the executive entity.

In one embodiment, the way by which the executive entity receives and presents the feedback information may include but is not limited to at least one of the followings.

As an example, the executive entity may determine the identifier of the target shared bike on the map based on information related to the target shared bike (such as the bike number or the location information) in the feedback information, and then only display the identifier of the target shared bike and remove identifiers of other shared bikes from the map. It should be noted that this process may also be implemented by the server. The server may use the processed map as feedback information.

As another example, the executive entity may display the identifiers of the shared bikes located near the target location on the map. The identifier of the target shared bike is different from identifiers of other shared bikes. The “different” herein may refer to that the identifiers themselves are different, or the identifiers are displayed in different ways.

As another example, if the feedback information comprises the prompt information of the target shared bike, the executive entity may use a speaker, a flashlight, etc., installed thereon to directly present the prompt information. Alternatively, the executive entity may present the prompt information of the target shared bike if a user's triggering operation of the identifier of the target shared bike displayed on the map is detected. This may prevent confusion caused by prompt information of multiple target shared bikes which are simultaneously presented.

As another example, if the feedback information comprises the bike number of the target shared bike, the executive entity may display the bike number of the target shared bike as the identifier on the map. Alternatively, the executive entity may display the bike number of the target shared bike at a location on the map corresponding to the identifier of the target shared bike.

At step 403, confirmation information on the feedback information is transmitted to the server when the user arrives where the target shared bike is currently located.

In this embodiment, the user may conduct an operation on the executive entity when arriving where the target shared bike is currently located. The executive entity may transmit confirmation information on the feedback information to the server after detecting the operation, so that the server may transmit an unlocking instruction to the target shared bike, and the user then may use the unlocked target shared bike. The confirmation information herein may be used to characterize that the user confirms to use the shared bike requested by him/her. It should be noted that the confirmation information usually does not comprise an unlocking key of the target shared bike (that is, information required by normal unlocking, such as QR code or three-dimensional code information).

It can be understood that the above-mentioned user's operation on the executive entity may be an operation for instructing to transmit confirmation information or the user's selection operation of the identifier of the target shared bike displayed on the screen of the executive entity. In the situation where the user has selected the target shared bike, the executive entity may generate confirmation information which is used to characterize the target shared bike selected by the user. For example, the confirmation information may comprise related information such as the bike number or the prompt information of the target shared bike. In this way, the server may transmit an unlocking instruction to the target shared bike indicated by the confirmation information.

In some implementations of this embodiment, the executive entity may also receive charging information of the target shared bike transmitted by the server, and present the charging information to the user, which facilitates the awareness of usage of the shared bike by the user in time. In addition, the user may also utilize the executive entity to provide feedback on bikes which lack unlocking keys and are malfunctioned.

The method for unlocking a shared bike provided in this embodiment may transmit a bike-use request to the server if a user's selection operation of identifiers of shared bikes located near a target location and displayed on a map is detected, so that the server transmits a bike-use instruction to a target shared bike so that the target shared bike sends out prompt information, and generates feedback information for the bike-use request. After that, the feedback information transmitted by the server may be received and presented. Confirmation information on the feedback information may be transmitted to the server when the user arrives where the target shared bike is currently located, so that the server transmits an unlocking instruction to the target shared bike. This enriches the methods for unlocking a shared bike, and shared bikes, especially shared bikes without unlocking keys, may be unlocked, which helps to improve utilization rate and user experience of shared bikes.

With further reference to FIG. 5, it shows a flow 500 of a fourth embodiment of a method for unlocking a shared bike according to the present application. The unlocking method may comprise the following steps.

At step 501, a bike-use instruction transmitted by a server is received, and prompt information is sent out.

In this embodiment, the execution entity of the method for unlocking a shared bike (e.g., the shared bikes 107, 108 as shown in FIG. 1) may receive a bike-use instruction transmitted by a server (e.g., the server 105 as shown in FIG. 1) by way of a wireless connection, and may send out prompt information when the bike-use instruction is received. This may facilitate the location of the bike by the user, reduction of the time that the user takes, and the improvement of user experience. The prompt information may include but is not limited to at least one of a sound prompt, a light prompt, or a vibration prompt. In this embodiment, the bike-use instruction may be generated by the server when receiving the bike-use request transmitted by a terminal (e.g., the terminals 101, 102, and 103 as shown in FIG. 1). The bike-use request herein may be generated by the terminal upon detecting a user's selection operation of identifiers of shared bikes located near a target location and displayed on a map. Reference may be made to related description of the embodiments of FIGS. 2 and 3, and details are not described herein again.

It should be noted that the executive entity in this embodiment may be a bike that can be unlocked normally or a bike that cannot be unlocked normally. Also, prompt information sent out by different executive entities may be the same or different. For example, prompt information sent out by shared bikes of different production batches may be different. As an example, the bike-use instruction may comprise prompt information allocated by the server. In this way, the executive entity may send out the prompt information indicated by the bike-use instruction after receiving the bike-use instruction.

At step 502, an unlocking instruction transmitted by the server is received, and an unlocking operation is performed.

In this embodiment, the executive entity may perform an unlocking operation when receiving an unlocking instruction transmitted by the server, and thus a lock installed on the executive entity is unlocked. In this way, the user who transmits the bike-use request may use the executive entity. Here, the unlocking instruction may be generated by the server when receiving confirmation information on feedback information transmitted by the terminal. The feedback information is usually generated and transmitted to the terminal by the server in case of having transmitted the above-mentioned bike-use instruction. Reference may be made to related description of the embodiments of FIGS. 2 and 3, and details are not described herein again.

In some embodiments, after a lock on the executive entity is unlocked, the executive entity may transmit to the server first feedback information which is used to characterize that the bike is currently in an unlocked state, so that the server may start charging and remove an identifier of the target shared bike from the map. After a lock on the executive entity is locked, the executive entity may transmit to the server second feedback information which is used to characterize that the bike is currently in a locked state, which enables the server to stop charging and redisplay the identifier of the target shared bike on the map.

The method for unlocking a shared bike proposed in this embodiment may send out prompt information when receiving a bike-use instruction transmitted by a server, which facilitate the location of the bike by the user. The method may also perform an unlocking operation when receiving the unlocking instruction transmitted by the server, which enables the user to use the bike. The bike-use instruction is generated by the server when receiving the bike-use request transmitted by a terminal. The bike-use request is generated by the terminal upon detecting a user's selection operation of identifiers of shared bikes located near a target location and displayed on a map. The unlocking instruction is generated by the server when receiving confirmation information on feedback information transmitted by the terminal. The feedback information is generated and transmitted to the terminal by the server in case of having transmitted the above-mentioned bike-use instruction. That is, without an unlocking key, the shared bike can also be unlocked through the interaction between the terminal and the server. This enriches the methods for unlocking a shared bike and helps to meet different users' needs. Meanwhile, it helps to increase utilization rate of shared bikes, especially bikes which cannot be unlocked normally.

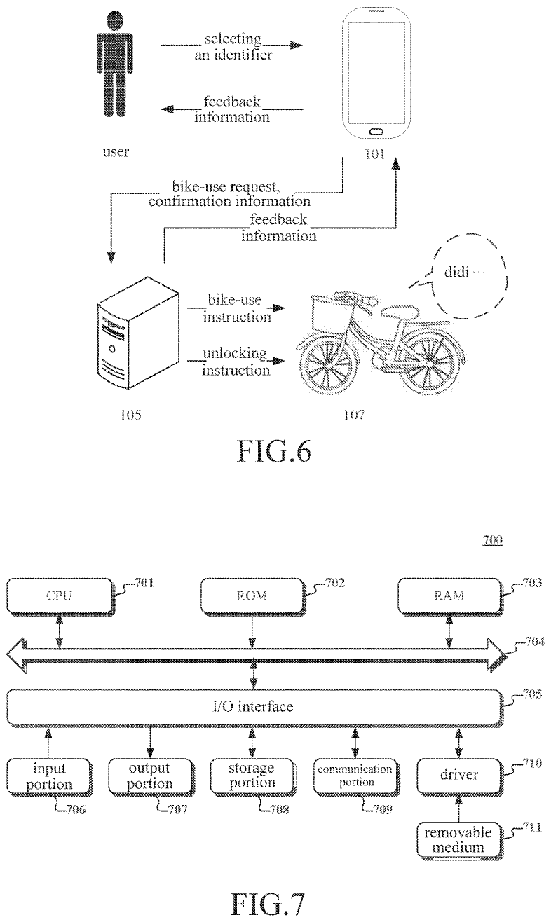

With reference to FIG. 6, FIG. 6 is a schematic diagram of an application scenario of the method for unlocking a shared bike according to the above-mentioned embodiments. In the application scenario of FIG. 6, a user may install a bike sharing-type application on a terminal 101 that he/she uses, and use a shared bike through this application.

At first, the user may open the bike sharing-type application on the terminal 101, select a distribution map of bikes that cannot be unlocked normally in the application, and enter a target location. At this time, identifiers of shared bikes located near the target location may be displayed on the map. After the user clicks and selects an identifier of a shared bike from the share bikes, the terminal 101 may generate a bike-use request comprising a bike number (such as number A) of the shared bike selected by the user, and transmit the bike-use request to a background server 105.

The server 105 may transmit a bike-use instruction to the shared bike with number A after receiving the bike-use request. At this time, the shared bike 107 with number A may continuously or intermittently send out prompt information of “didi” after receiving the bike-use instruction. Meanwhile, the server 105 may generate feedback information of “The bike-use instruction has been transmitted to the shared bike with number A”, and transmit the feedback information to the terminal 101.

The terminal 101 may present the feedback information to the user. When the user arrives near the target location, if it is found that only one bike that cannot be unlocked normally is sending out prompt information of “didi”, the user may determine that the bike is the shared bike requested by himself/herself. Further, the user may also compare the bike number in the feedback information with the bike number on the shared bike. If these two bike numbers are the same, the user may determine that the bike is the shared bike requested by himself/herself. At this time, the user may transmit confirmation information to the server 105 through a confirmation button displayed on the terminal 101.

The server 105 may transmit an unlocking instruction to the shared bike 107 with number A after receiving the confirmation information. At this time, the shared bike 107 may perform an unlocking operation, that is, unlock the lock on it.

It should be noted that if the server 105 does not receive confirmation information transmitted by the terminal 101 within a preset time period (such as 20 minutes), it is considered that the user has given up using the shared bike. At this time, the server 105 may clear information related to this bike-use request, and transmit a cancellation instruction to the shared bike 107 to stop it from sending out prompt information. Meanwhile, a stored state of the shared bike 107 may be changed to “available”. This helps to increase effective use rate of shared bikes, i.e., the percentage of shared bikes that have been actually used by users.

Reference is made to FIG. 7 below, which shows a schematic structural diagram of a computer system 700 suitable for implementing an electronic device (e.g., terminals 101, 102, and 103 or a server 105 as shown in FIG. 1) of the embodiments of the present application. The electronic device shown in FIG. 7 is merely an example, and should not impose any limitation on the functions and scope of use of the embodiments of the present application.

As shown in FIG. 7, the computer system 700 includes a central processing device (CPU) 701, which can perform various appropriate actions and processing according to the programs stored in a read-only memory (ROM) 702 or programs loaded from a storage portion 708 into a random access memory (RAM) 703. Various programs and data necessary for the operation of the system 700 are also stored in RAM 703. The CPU 701, ROM 702, and RAM 703 are connected to each other via a bus 704. An input/output (I/O) interface 705 is also connected to the bus 704.

The following components are connected to the I/O interface 705, which include: an input portion 706 including for example a touch screen, a button, a keyboard, a mouse, a microphone, a camera etc.; an output portion 707 including for example a cathode ray tubes (CRT) and/or a Liquid Crystal Display (LCD) etc. and a speaker; the storage portion 708 including for example a hard disk etc.; and a communication portion 709 including a network interface card such as a LAN (Local Area Network) card, a modem, and the like. The communication portion 709 performs communication processing via a network such as the Internet. Drivers 710 are also connected to the I/O interface 705 when necessary. Removable medium 711, such as a magnetic disk, an optical disk, a magnetic-optical disk, a semiconductor memory, etc. is stalled on the drivers 710 when necessary, so that a computer program read out therefrom is installed into the memory portion 708.

In particular, according to the embodiments of the present disclosure, the processes described above with reference to the flowcharts may be implemented as computer software programs. For example, embodiments of the present disclosure include a computer program product including a computer program carried on a computer-readable medium, the computer program containing program code for performing a method shown in a flowchart. In such an embodiment, the computer program may be downloaded from a network through the communication portion 709 and installed, and/or installed from the removable medium 711. When the computer program is executed by the central processing device (CPU) 701, the above functions defined in the method of the present application are performed. It should be noted that the computer-readable medium of the present application may be a computer-readable signal medium or a computer-readable storage medium or any combination of the above two. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to: electrical connections with one or more wires, portable computer magnetic disks, hard disks, random access memory (RAM), read-only memory (ROM), erasable Programming read-only memory (EPROM or flash memory), optical fiber, portable compact disk read-only memory (CD-ROM), optical storage device, magnetic storage device, or any suitable combination of the foregoing. In the present application, a computer-readable medium may be any tangible medium that contains or stores a program that can be used by or in combination with an instruction execution system, apparatus, or device. In the present application, a computer-readable signal medium may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal medium may also be any computer-readable medium other than a computer-readable storage medium, and the computer-readable medium may send, propagate, or transmit a program for use by or in connection with an instruction execution system, apparatus, or device. Program code embodied on a computer-readable medium may be transmitted using any appropriate medium, including but not limited to: wireless, wired, optical fiber cable, RF, etc., or any suitable combination of the foregoing.

The flowchart and block diagrams in the accompanying drawings illustrate the architecture, functionality, and operation of possible implementations of systems, methods and computer program products according to various embodiments of the present application. In this regard, each block in the flowchart or block diagram may represent a module, a program segment, or a part of code, a portion of which contains one or more executable instructions for implementing a specified logical function. It should also be noted that in some alternative implementations, the functions labeled in the blocks may also occur in a different order than those labeled in the drawings. For example, two successively represented blocks may actually be executed substantially in parallel, and they may sometimes be executed in a reverse order, depending on the functions involved. It should also be noted that each block in the block diagrams and/or flowcharts, and combinations of blocks in the block diagrams and/or flowcharts, can be implemented by a dedicated hardware-based system that performs the specified function or operation, or it can be implemented with a combination of dedicated hardware and computer instructions.

The devices described in the embodiments of the present application may be implemented by software or hardware. The described device may also be provided in a processor, for example, it may be described as: a processor including a bike-use request receiving device, a bike-use instruction transmitting device, a feedback information transmitting device, and an unlocking instruction transmitting device. As another example, it may also be described as: a processor including a bike-use request transmitting device, a feedback information receiving device, and a confirmation information transmitting device. The name of these devices does not constitute a limitation on the device itself in some cases. For example, the bike-use request receiving device may also be described as “a device for receiving a bike-use request transmitted by a terminal”.

As another aspect, the present application further provides a computer-readable medium, which may be included in the electronic device described in the foregoing embodiments; or may exist alone without being assembled into the electronic device. For example, the above computer-readable medium carries one or more programs. When the above one or more programs are executed by the electronic device, the electronic device is caused to: receive a bike-use request transmitted by a terminal, and the bike-use request is generated by the terminal upon detecting a user's selection operation of identifiers of shared bikes located near a target location and displayed on a map; transmit a bike-use instruction to a target shared bike so that the target shared bike sends out prompt information, and the target shared bike comprises the shared bike requested by the bike-use request; generate feedback information for the bike-use request, and transmit the feedback information to the terminal; and receive confirmation information on the feedback information transmitted by the terminal, and transmit an unlocking instruction to the target shared bike.

As another example, when the above one or more programs are executed by the electronic device, the electronic device is also caused to: transmit a bike-use request to a server, if a user's selection operation of identifiers of shared bikes located near a target location and displayed on a map is detected, so that the server transmits a bike-use instruction to a target shared bike so that the target shared bike sends out prompt information, and generates feedback information for the bike-use request, and the target shared bike comprises the shared bike requested by the bike-use request; receive and present the feedback information transmitted by the server; and when the user arrives where the target shared bike is currently located, transmit confirmation information on the feedback information to the server, so that the server transmits an unlocking instruction to the target shared bike.

### DISCLOSURE

What is claimed is:

1. A method, implemented at a server, for unlocking a shared bike comprising:
receiving a bike-use request transmitted by a terminal, wherein the bike-use request is generated by the terminal upon detecting a user's selection operation of identifiers of shared bikes located near a target location and displayed on a map;
transmitting a bike-use instruction to a target shared bike so that the target shared bike sends out prompt information, wherein the target shared bike comprises the shared bike requested by the bike-use request;
generating feedback information for the bike-use request, and transmitting the feedback information to the terminal; and
receiving confirmation information on the feedback information transmitted by the terminal, and transmitting an unlocking instruction to the target shared bike.

2. The method according to claim 1, wherein the shared bikes displayed on the map comprise bikes that cannot be unlocked normally.

3. The method according to claim 2, wherein transmitting the bike-use instruction to the target shared bike comprising:
determining whether the target shared bike is an available bike that cannot be unlocked normally; and transmitting the bike-use instruction to the target shared bike if it is determined that the target shared bike is an available bike that cannot be unlocked normally.

4. The method according to claim 1, wherein the prompt information comprises at least one of a sound prompt, a vibration prompt or a light prompt; and
wherein prompt information sent out by shared bikes of different production batches are different; or
transmitting the bike-use instruction to the target shared bike comprising:
acquiring current location information of the target shared bike, allocating prompt information to the target shared bike; generating a bike-use instruction comprising the allocated prompt information, and transmitting the bike-use instruction to the target shared bike; wherein prompt information sent out by shared bikes located in a same area are different, or prompt information sent out by shared bikes located in a same area within a same time period are different.

5. The method according to claim 4, wherein generating the feedback information for the bike-use request comprising:
acquiring the prompt information of the target shared bike, and generating feedback information comprising the prompt information of the target shared bike.

6. The method according to claim 1, wherein the method further comprising:
receiving first feedback information transmitted by the target shared bike which is used to characterize that the bike is currently in an unlocked state, starting charging, and removing an identifier of the target shared bike from the map; and
receiving second feedback information transmitted by the target shared bike which is used to characterize that the bike is currently in a locked state, stopping charging, and redisplaying the identifier of the target shared bike on the map; and
transmitting charging information to the terminal.

7. The method according to claim 2, wherein before transmitting the bike-use instruction to the target shared bike, the method further comprising:
determining whether a number of shared bikes requested by the bike-use request is one; and
in response to determining that the number of shared bikes requested by the bike-use request is not one, selecting at least one shared bikes near the target location as target shared bike(s).

8. The method according to claim 7, wherein if at least two shared bikes near the target location are selected as target shared bikes, transmitting the unlocking instruction to the target shared bike comprising:
acquiring current location information of the user and the target shared bikes; selecting a target shared bike from the target shared bikes according to the acquired current location information; and transmitting the unlocking instruction to the selected target shared bike.

9. The method according to claim 7, wherein if at least two shared bikes near the target location are selected as target shared bikes and prompt information sent out by the target shared bikes are different, generating the feedback information for the bike-use request comprising:
acquiring prompt information and/or bike numbers of the target shared bikes, and generating feedback information comprising the prompt information and/or the bike numbers of the target shared bikes; and
receiving confirmation information on the feedback information transmitted by the terminal, and transmitting the unlocking instruction to the target shared bike comprising:
receiving the confirmation information transmitted by the terminal, and transmitting the unlocking instruction to a target shared bike indicated by the confirmation information, wherein the confirmation information is used to characterize the target shared bike selected by the user.

10. A method, implemented at a terminal, for unlocking a shared bike comprising:
transmitting a bike-use request to a server upon detecting a user's selection operation of identifiers of shared bikes located near a target location and displayed on a map is detected, so that the server transmits a bike-use instruction to a target shared bike so that the target shared bike sends out prompt information, and generates feedback information for the bike-use request, wherein the target shared bike comprises the shared bike requested by the bike-use request;
receiving and presenting the feedback information transmitted by the server; and
transmitting confirmation information on the feedback information to the server when the user arrives where the target shared bike is currently located, so that the server transmits an unlocking instruction to the target shared bike.

11. The method according to claim 10, wherein the shared bikes displayed on the map comprise bikes that cannot be unlocked normally.

12. The method according to claim 11, wherein the shared bikes displayed on the map further comprise bikes that can be unlocked normally, and identifiers of the bikes that can be unlocked normally are different from identifiers of the bikes that cannot be unlocked normally; and
transmitting the bike-use request to the server comprising:
determining whether the shared bike selected by the user comprises a bike that cannot be unlocked normally; and transmitting a bike-use request to the server if it is determined that the shared bike selected by the user comprises a bike that cannot be unlocked normally.

13. The method according to claim 10, wherein receiving and presenting the feedback information transmitted by the server comprising at least one of:
displaying an identifier of the target shared bike on the map, and removing identifiers of other shared bikes;
displaying identifiers of shared bikes located near the target location on the map, wherein an identifier of the target shared bike is different from identifiers of other shared bikes;
presenting the prompt information of the target shared bike upon detecting a user's triggering operation of an identifier of the target shared bike displayed on the map, wherein the feedback information comprises the prompt information of the target shared bike;
displaying a bike number of the target shared bike on the map as an identifier, or displaying a bike number of the target shared bike at a location on the map corresponding to the identifier of the target shared bike, wherein the feedback information comprises the bike number of the target shared bike.

14. The method according to claim 10, wherein the method further comprising:
receiving and presenting charging information of the target shared bike transmitted by the server.

15. An electronic device, comprising:
one or more processors; and
a storage device having one or more programs stored thereon;
wherein the one or more programs, when executed by the one or more processors, cause the one or more processors to implement the method as recited in claim 1.
